(19) United States
(12) Patent Application Publication
(10) Pub. No.: US 2023/0230378 A1
(43) Pub. Date: Jul. 20, 2023

(54) METHOD AND SYSTEM FOR SELECTING HIGHLIGHT SEGMENTS

(71) Applicant: MOBIUS LABS GMBH, Berlin (DE)

(72) Inventors: Dominic RÜFENACHT, Muri b. Bern (CH); Appu SHAJI, Berlin (DE)

(21) Appl. No.: 18/001,174

(22) PCT Filed: Jun. 8, 2021
(86) PCT No.: PCT/EP2021/065314

§ 371 Date: Dec. 8, 2022

(30) Foreign Application Priority Data
Jun. 8, 2020 (EP) 20178817.1

(51) Int. Cl. G06V 20/40; H04N 21/8549; H04N 21/845

(52) U.S. Cl. CPC G06V 20/47; H04N 21/8549; H04N 21/8456

(57) ABSTRACT

Described are methods and systems for selecting a highlight segment. The computer-implemented method comprises receiving a sequence of frames, and at least one user data; via a converting module, for each frame, selecting a local neighborhood around it. said neighborhood comprising at least one frame; and converting each neighborhood into a feature vector; via a high-lighting module, assigning a score to each of the feature vectors based on the user data; via a selection module, selecting at least one highlight segment based on the scoring of the feature vectors; and via an outputting module, outputting the highlight segment. The system comprises a receiving module configured to receive a sequence of frames, and at least one user data; a converting module configured to select a local neighborhood around each frame, said neighborhood comprising at least one frame, and convert each neighborhood into a feature vector, a highlighting module configured to assign a score to each of the feature vector based on the user data; a selection module configured to select at least one highlight segment based on the scoring of the feature vectors; and an output component configured to output the highlight segment.

### FIELD

The invention relates to image and video processing. More specifically, the invention is concerned with selecting highlight segments, particularly tailored towards users.

### INTRODUCTION

Video consumption has been steadily on the rise for the last few years. With more and more selection available, users may find it hard to choose which videos to spend time watching. Content providers often show a preview or “highlight reel” of videos to give users a taste of what they are about. Such previews are often automatically generated. Sometimes, the generation is random, while other times it can also be based on generic “user preference” criteria. For example, videos about car racing might show a few seconds of a particularly exciting manoeuvre or a dangerous stunt so as to attract viewers to watch the entire video.

Generating snapshots or “gifs” representing videos is known in the art. For example, US patent application 2017/0133054 A1 describes systems and methods for automatically extracting and creating an animated Graphics Interchange Format (GIF) file from a media file. The disclosed systems and methods identify a number of GIF candidates from a video file, and based on analysis of each candidate's attributes, features and/or qualities, as well as determinations related to an optimal playback setting for the content of each GIF candidate, at least one GIF candidate is automatically provided to a user for rendering.

Also, U.S. Pat. No. 10,074,015 B1 discloses methods, systems, and media for summarizing a video with video thumbnails. In some embodiments, the method comprises: receiving a plurality of video frames corresponding to the video and associated information associated with each of the plurality of video frames; extracting, for each of the plurality of video frames, a plurality of features; generating candidate clips that each includes at least a portion of the received video frames based on the extracted plurality of features and the associated information; calculating, for each candidate clip, a clip score based on the extracted plurality of features from the video frames associated with the candidate clip; calculating, between adjacent candidate clips, a transition score based at least in part on a comparison of video frame features between frames from the adjacent candidate clips; selecting a subset of the candidate clips based at least in part on the clip score and the transition score associated with each of the candidate clips; and automatically generating an animated video thumbnail corresponding to the video that includes a plurality of video frames selected from each of the subset of candidate clips.

Generating highlights or video previews based on average or general user interest can be advantageous, as it can be done quickly and efficiently. However, it lacks personalization. Indeed, what one user may think of as a highlight of a video, another user might not find interesting at all. For example, in car racing videos, some users might find maneuvers such as turns or twists of the road most interesting, while others would prefer to see close-ups of the driver's face. Therefore, it can be useful to personalize video highlights depending on the user.

Some prior art discussing the personalization of highlight videos is known. For instance, U.S. Pat. No. 10,102,307 B2 discloses method, system, and programs for a multi-phase ranking system for implementation with a personalized content system. The disclosed method, system, and programs utilize a weighted AND system to compute a dot product of the user profile and a content profile in a first phase, a content quality indicator in the second phase and a rules filter in a third phase.

Further, Sun, Min & Farhadi, Ali & Seitz, Steve. (2014). Ranking Domain-Specific Highlights by Analyzing Edited Videos. 8689. 787-802. 10.1007/978-3-319-10590-1_51 discloses a fully automatic system for ranking domain-specific highlights in unconstrained personal videos by analyzing online edited videos. A novel latent linear ranking model is proposed to handle noisy training data harvested online. Specifically, given a search query (domain) such as “surfing”, the system mines the Youtube database to find pairs of raw and corresponding edited videos. Leveraging the assumption that edited video is more likely to contain highlights than the trimmed parts of the raw video, pair-wise ranking constraints are obtained to train the model.

Also, Garcia del Molino, Ana & Gygli, Michael. (2018). PHD-GIFs: Personalized Highlight Detection for Automatic GIF Creation. 600-608. 10.1145/3240508.3240599 discloses that highlight detection models are typically trained to identify cues that make visual content appealing or interesting for the general public, with the objective of reducing a video to such moments. However, this “interestingness” of a video segment or image is subjective. Thus, such highlight models provide results of limited relevance for the individual user. On the other hand, training one model per user is inefficient and requires large amounts of personal information which is typically not available. To overcome these limitations, we present a global ranking model which can condition on a particular user's interests. Rather than training one model per user, our model is personalized via its inputs, which allows it to effectively adapt its predictions, given only a few user-specific examples. To train this model, we create a large-scale dataset of users and the GIFs they created, giving us an accurate indication of their interests. Our experiments show that using the user history substantially improves the prediction accuracy. On a test set of 850 videos, our model improves the recall by 8% with respect to generic highlight detectors. Furthermore, our method proves more precise than the user-agnostic baselines even with only one single person-specific example.

### SUMMARY

Some of the prior art discusses various models for providing personalized highlighting results. The present disclosure discusses models that allow for personalization without large modification or retraining, and where concurrent computation may not be required to get the personalized output.

It is the object of the present invention to provide an improved and reliable way of selecting highlight segments. It is further the object of the present invention to provide methods and systems for robust and refined personalized highlight detection in videos. It is also the object of the invention to provide a versatile model for providing personalized output related to highlighting.

In a first embodiment, a computer-implemented method for selecting a highlight segment is disclosed. The method comprises receiving a sequence of frames, and at least one user data. The method further comprises, via a converting module, for each frame, selecting a local neighborhood around it, said neighborhood comprising at least one frame. The method also comprises, via a converting module converting each neighborhood into a feature vector. The method further comprises, via a highlighting module, assigning a score to each of the feature vectors based on the user data. The method also comprises, via a selection module, selecting at least one highlight segment based on the scoring of the feature vectors. The method further comprises, via an outputting module, outputting the highlight segment.

The sequence of frames may refer to a plurality of images (such as e.g. consecutive photographs or “burst mode” images), a video, an augmented video (e.g. with added computer-generated objects, reactions, comments or the like), and/or a processed video. The frames may comprise image frames, video frames, point clouds, light fields, frames from a 3D video, compilation frames from a plurality of cameras, encoding or projections of the real world/computer generated content or the like.

The user data may refer to data that is reflective of a particular user's preferences. In other words, the user data can be personalized based on the user. The user in question may be the recipient of the highlight segment output by the present method. Furthermore, the user may comprise a plurality of users and/or a group of users that may share interests in a way that would lead to similar preferred personalized output.

The neighborhood of a given frame may refer to a collection of frames selected from the sequence and comprising the given frame, as well as several of its neighbors based on the sequence. In its simplest form, the neighborhood may also correspond to the frame in question itself. In this case, the neighborhood would comprise a sole frame.

In the case of a video serving as the input (i.e. where the sequence of frames comprises a video), the neighborhood may comprise an excerpt or piece of the input video, centered around the given frame, and comprising frames adjacent to it based on the video's temporal sequence. Adjacent as used herein does not imply that the frames are directly neighboring one another in the original video, as some frames may be skipped if a video is sampled. In other words, the frames of the video may be temporally subsampled, so that the adjacent frames may not have been so in the original input video. Furthermore, neighbors having a different time spacing (or temporal stride) may also be selected. For example, if a given frame k is evaluated, frames k−4, k−2, k, k+2, k+4 may be selected to form part of the neighborhood. This can be useful for e.g. increasing the speed of the output without compromising on the quality of the resulting highlight (for example, the original input video may be taken at a framerate of 30 frames/second, which may be sampled at 10 frames/second to speed up computations).

The feature vector may refer to a representation in a multidimensional vector space. In other words, the feature vector may comprise an embedding. In this way, each frame (represented by its neighborhood) can be converted or mapped into a quantifiable object that can be easily mathematically manipulated and compared to other such objects. The conversion of images or sequences of images (such as frames) into feature vectors is generally known in the art, and the skilled person may use one of such known methods to perform this step. For example, feature vectors may be 1024/2048-dimensional vectors computed by using neural networks. In another example, the feature vectors may comprise 1280 dimensions.

The highlight segment may refer to a subset of the input sequence of frames, most likely to be preferred by the user, based on the user data and the above analysis.

The present method can be advantageously used to offer users “highlights” of certain videos, sequence of frames or the like. In other words, for any input sequence of frames, a personalized highlight sequence can be output.

In the case of an input video, the output (i.e. the highlight segment) may comprise an excerpt of the input video of a few seconds. The excerpt is selected in such a way that it is likely to be the most appealing or interesting part of the video for a given user (based on the user data). The method can be used by e.g. content providers and aggregators that offer platforms for users to view and/or share videos. Advantageously, users can then “preview” the video and decide, based on the highlight, whether they would be interested in watching it in its entirety.

In some embodiments, the user data can be indicative of a user's preference for video segments. That is, the user data preferably reflects a given user's likes and dislikes. For example, if a user likes to see close up of football goals, several video segments depicting those can be used as user data. The more personalised and detailed user data is made, the better the resulting predicted highlight segment will reflect the user's preferences.

In some embodiments, the user data can comprise at least one reference video segment. In some such embodiments, the reference video segment can be selected by the user. In some such embodiments, the method can further comprise receiving a plurality of user-selected video segments indicative of user preference and generating user data based on them. If a given user inputs their own preferences by specifically submitting video segments they have previously enjoyed, the resulting personalised highlight segment can be fairly accurate and exhibit a large degree of personalisation, since the user may know best what they would prefer.

In other embodiments where the user data comprises reference video segments, the reference video segment can be automatically generated based on a user's video viewing habits. This can be useful, as the user may not want to manually input their likes/dislikes for video segments, and may instead prefer to let them be automatically collected and/or curated.

In other such embodiments, the reference video segment can be generated based on viewing habits of a plurality of reference users. There may be a database storing a plurality of video segments reflecting average user preferences. The user data can be generated or created based on this database, provided some further information is known about the given user (so that relevant members of the database can be selected to serve as user data). In some such embodiments, the generation of the reference video segment can further account for at least one user-specific characteristic.

In some embodiments, the method can further comprise generating and maintaining a database of video segments and selecting at least one video segment as user data based on at least one characteristic associated with the user. The characteristic associated with the user may comprise demographic information, user-generated content (e.g. comments, emojis, chat logs synchronized with the video, reactions to certain specific parts of the video (with the corresponding timestamp) or the like added to other videos), or other data associated with the user and reflective of their interests.

In some embodiments, the method can further comprise, prior to the inputting step, receiving at least one reference video segment indicative of a user's preference and converting it into the user data. The reference video segment may be received from the user, from a curated database and/or retrieved from another source. In some such embodiments, converting the video segment can comprise converting the reference video segment into a reference feature vector. In some such embodiments, the user data can comprise a plurality of reference feature vectors obtained by converting a plurality of reference video segments indicative of a user's preference. The plurality of reference video segments can also be indicative of different user preferences. The reference video segments can be grouped into sets, each said set indicative of a particular user preference, and each set can be converted into a distinct user data subset comprising a subset of the reference feature vectors associated with the reference video segments forming part of it. In some such embodiments, the feature vectors can be assigned a score based on each user data subset. A score can be assigned based on a comparison to each of the user data subsets for each feature vector. Furthermore, the method can also comprise assigning a weight to each of the data subset, said weight associated with the user's relative preference towards it.

Put differently, user data can comprise different categories of video segments that a given user may find interesting. For example, a user might enjoy videos of cats jumping, and of football goals. Reference video segments depicting each of those two distinct preferences may form subsets of user data. Separating such preferences can allow to provide a more detailed and accurate highlight segment from the input sequence of frames, since subcategories of user preferences can be used as a basis for selecting the highlight of the input. In a specific example, the input sequence of frames may comprise a video of a dog running and jumping. The user data may then comprise the separate sets relating to cats jumping and to football goals. When the input video is compared to each of these sets, the cat jumping videos might provide a better reference or benchmark to select the ultimate highlight of the video. Therefore, allowing for different sets within the user data and comparing them separately to the input can yield far better personalised results for a given user.

In some embodiments, the user data can comprise indication of frequency with which the given user watched a video and/or predetermined category of videos. That is, not only a user's preferences for video segments can be encompassed by the user data, but the relative preferences to each of the categories may also be evaluated. In a concrete example, if a user watches 10 times more videos of cats jumping compared to football goals, the user data might be weighted heavier towards those videos, and comparison of the input with the user data might also assign higher scores to frames and neighborhoods more similar to the cats jumping reference segments.

In some embodiments, the user data can comprise auxiliary data related to at least one video. Auxiliary data can comprise metadata such as comments under videos, reactions to videos, added computer-generated content (e.g. added animations or gifs of fireworks or the like at specific points in time), augmented reality content, as well as further data that can be associated with reference videos or other reference content (e.g. sequences of frames, plurality of images).

In some embodiments, the method can further comprise, prior to selecting the neighborhood for each frame, generating at least one segment, each segment comprising at least one frame of the sequence of frames. The generation can be performed via a segmentation module. The segments may correspond to shots of a video. In other words, an abrupt change of scene can indicate a boundary between segments. In continuous footage videos (e.g. videos shot via a single camera without editing or stopping), there may only be one segment for the whole video. In videos with changes of scene, the segments may correspond to each scene.

In some such embodiments, each neighborhood can be comprised within a single segment. That is, the neighborhoods may be selected in a way that segment boundaries are not crossed. This can be particularly advantageous for ensuring that the neighborhoods which are converted into feature vectors do not exhibit any abrupt change of scenes (due to e.g. a shot boundary being part of the neighborhood). Put simply, if a video changes from a scene of a cat jumping to a cat eating, the neighborhoods adjoining the boundary between these shots (or scene transitions) are preferably contained within each respective scene, and do not cross over. In this way, the conversion into feature vectors and the subsequent comparison with user data and assigning of a score can be more accurate and fine-grained.

In some such embodiments, the segmentation module can comprise a shot detector. Various shot detectors are known in the art. Those can also be known as shot transition detectors or cut detectors, and are generally configured to detect transitions between shots in videos. In some such embodiments, each segment can correspond to a shot detected by the shot detector.

In some such embodiments, generating the plurality of segments can be performed by a machine learning algorithm. The machine learning algorithm can comprise a neural network. Generating the segments can be performed by a convolutional neural network in some preferred embodiments.

The segments can be generated from the video by converting it to a one-dimensional signal, localizing its extrema and selecting intervals around them. The segments can be generated by converting the video into a segmentation curve and splitting the curve into segments such that each segment can comprise a local maximum of the segmentation curve, and each segment can start and end at a local minimum immediately preceding and following the said local maximum.

In some embodiments wherein the user data can comprise reference video segments converted into reference feature vectors, assigning scores to the feature vectors can comprise comparing each of the feature vectors with each of the reference feature vectors and assigning scores to the associated neighborhoods based on each input feature vectors' distance with respect to closest matching of the user feature vectors. In other words, input sequence of frames can be processed (i.e. by converting it into feature vectors) and compared to reference video segments that have been similarly processed (by converting them into reference feature vectors). In this way, the similarity of different frames (represented by their neighborhoods) of the input can be compared to the reference videos that correspond to a user's interest.

In some such embodiments wherein a plurality of user data subsets are present, assigning scores to the feature vectors can further comprise determining which user data subset is closest to each feature vector and assigning it a value based on a comparison between the subset of reference feature vectors and said feature vector. This can be particularly useful when user data is indicative of a plurality of distinct (and possibly incompatible) user interests. For example, a user may be interested in close-ups of football player faces after a goal, as well as videos of ocean waves rolling in. The input sequence of frames can then advantageously be compared to those distinct user interests separately, and a highlight segment based on a closest match of this separate comparison can be generated.

In some such embodiments, the method can further comprise accounting for the relative weight of each of the user data subset when assigning scores to the feature vectors. This can be useful if a user strongly prefers one interest over another, e.g. they watch a lot more videos of ocean waves rolling in than close-ups of football player faces. In this way, the relative interest of the user for one set over another can be accounted for, and the resulting highlight segment be more accurate.

In some embodiments, assigning scores to the feature vectors can further comprise using a machine learning algorithm. The machine learning algorithm can comprise a neural network. The input into the neural network can comprise a difference between each feature vector and the data subset that is closest to it. In some such embodiments, the method can further comprise, prior to any other steps, training the neural network to receive a plurality of feature vectors and output assigned scores for feature vectors. In some such embodiments, no further training of the neural network may be performed based on the input user data. In other words, the neural network need not be retrained based on each new input of user data. Instead, it uses its existing training and takes the new user data as input, with the output being weighted based on the user data. This is particularly advantageous, as retraining the neural network can take a long time, and decrease the efficiency of the present method.

In some embodiments, the method can further comprise the selection module constructing the highlight segment. As described herein, “selecting the highlight segment” and “constructing the highlight segment” may be used interchangeably. The highlight segment may comprise a subset of the input sequence of frames. Therefore, selecting a few of these frames as the highlight corresponds to “constructing” the highlight segment.

In some such embodiments, the highlight segment can comprise a plurality of frames selected from the input sequence of frames. The highlight segment can be constructed by evaluating assigned scores of all feature vectors corresponding to the frames and their neighboring frames and identifying a plurality of neighboring frames with an average best assigned score. Put differently, the scores of all input frames are considered together, and not individually. This can be useful, as, due to various sources of noise, scores of individual frames may present inaccuracies. Evaluating the scores altogether allows to exclude such outliers and focus on the neighboring frames that have all been scored highly.

In some such embodiments, the method can further comprise constructing the highlight segment in such a way that it comprises a predetermined length. The length can refer to the number of frames that are comprised in the highlight segment (in the case of a video, this length then also determines the temporal length of the highlight segment). The predetermined highlight segment length can be based on predetermined segment classification. Segment classification can comprise categories such as goals at sporting events, animal interactions, or the like. In the case of goals, users may prefer to also see the build-up to a successful goal. The highlight segment may then comprise not only frames that were assigned a high score, but also some more neighboring ones, which would correspond to the events happening right before the goal. In the case of e.g. jumping animals, the user may not be interested in the build-up, and therefore only highly scored frames may then be selected for the highlight segment. There may also be reasons to limit segment length to a certain number of frames or a certain resulting playtime. In this case, the highlight segment can be adjusted accordingly.

In some embodiments, the method can further comprise constructing the highlight segment in such a way that it is comprised in one segment. In other words, the highlight segment would preferably not include any boundaries between segments, which may correspond to shot boundaries. This is advantageous, as the personalised highlight segment would preferably not comprise jumps between scenes or abrupt changes of the setting.

In a second embodiment, a system for selecting a highlight segment is disclosed. The system comprises a receiving module configured to receive a sequence of frames, and at least one user data. The system also comprises a converting module configured to select a local neighborhood around each frame, said neighborhood comprising at least one frame. The converting module is also configured to convert each neighborhood into a feature vector. The system further comprises a highlighting module configured to assign a score to each of the feature vectors based on the user data. The system also comprises a selection module configured to select at least one highlight segment based on the scoring of the feature vectors. The system further comprises an output component configured to output the highlight segment.

In some embodiments, the system can further comprise at least one database comprising a plurality of user data associated with particular users. The database can comprise a plurality of reference video segments. The reference video segments can be user-selected and indicative of user preference for video segments. The user data can be generated from a plurality of video segments based on at least one user-specific characteristic. This is also further detailed below with regard to corresponding method embodiments.

In some embodiments, the user data can comprise a plurality of reference feature vectors obtained by converting a plurality of reference video segments indicative of a user's preference. The plurality of reference video segments can be indicative of different user preferences. The reference video segments can be grouped into sets, each said set indicative of a particular user preference, and each set can be converted into a distinct user data subset comprising a subset of the reference feature vectors associated with the reference video segments forming part of it. The feature vectors can be assigned a score based on each user data subset. Each feature vector can be assigned a score based on a comparison to each of the user data subsets. The highlighting module can be further configured to assign a weight to each of the data subset, said weight associated with the user's relative preference towards it. The user data subsets are also further detailed above, referring to the method embodiments. The same description applies herein.

In some embodiments, the user data can comprise indication of frequency with which the given user watched a video and/or predetermined category of videos.

In some embodiments, the user data can comprise auxiliary data related to at least one video. The auxiliary data can refer to various metadata (e.g. comments under a video, reactions to particular parts of it, computer-generated additions to certain shots or frames, and the like) and can be used to further precisely curate a user's preferences and generate a more accurate highlight segment.

In some embodiments, the system can further comprise a segmentation module configured to generate a plurality of segments, each comprising a plurality of frames of the video (but minimum segment size may also comprise a single frame). Each neighborhood can be comprised within a single segment. The segmentation module can comprise a shot detector and each segment can correspond to a shot detected by the shot detector. Generating the plurality of segments can be performed by a machine learning algorithm such as e.g. a neural network. The use of the segmentation module is also detailed above and applies to the system embodiments as well.

In some embodiments, the highlighting module can be configured to use a machine learning algorithm (e.g. a pretrained neural network) to assign scores to the feature vectors.

In some embodiments, the selection module can be configured to construct the highlight segment. The highlight segment can comprise a plurality of frames selected from the input sequence of frames. The selection module can be configured to construct the highlight segment by evaluating assigned scores of all feature vectors corresponding to the frames and their neighboring frames and identifying a plurality of neighboring frames with an average best assigned score.

In some embodiments, the system can further comprise a user terminal configured to display at least the highlight segment output by the output component.

The system can be generally preferably configured to carry out the method according to any of the preceding and previously described and detailed method embodiments, with the corresponding advantages.

The present invention is also defined by the following numbered embodiments.

Below is a list of method embodiments. Those will be indicated with a letter “M”. Whenever such embodiments are referred to, this will be done by referring to “M” embodiments.

M1. A computer-implemented method for selecting a highlight segment, the method comprising
Receiving
   A sequence of frames, and
   At least one user data;
Via a converting module,
   For each frame, selecting a local neighborhood around it, said neighborhood comprising at least one frame; and
   Converting each neighborhood into a feature vector;
Via a highlighting module, assigning a score to each of the feature vectors based on the user data;
Via a selection module, selecting at least one highlight segment based on the scoring of the feature vectors; and
Via an outputting module, outputting the highlight segment.

### Embodiments Related to the User Data

M2. The method according to the preceding embodiment wherein the user data is indicative of a user's preference for video segments.

M3. The method according to any of the preceding embodiments wherein the user data comprises at least one reference video segment.

M4. The method according to the preceding embodiment wherein the reference video segment is selected by the user.

M5. The method according to the preceding embodiment wherein the method further comprises receiving a plurality of user-selected video segments indicative of user preference and generating user data based on them.

M6. The method according to any of the preceding embodiments and with features of embodiment M3 wherein the reference video segment is automatically generated based on a user's video viewing habits.

M7. The method according to any of the preceding embodiments and with features of embodiment M3 wherein the reference video segment is generated based on viewing habits of a plurality of reference users.

M8. The method according to the preceding embodiment wherein the generation of the reference video segment further accounts for at least one user-specific characteristic.

M9. The method according to any of the preceding embodiments further comprising generating and maintaining a database of video segments and selecting at least one video segment as user data based on at least one characteristic associated with the user.

M10. The method according to any of the preceding embodiments further comprising, prior to the inputting step, receiving at least one reference video segment indicative of a user's preference and converting it into the user data.

M11. The method according to the preceding embodiment wherein converting the video segment comprises converting the reference video segment into a reference feature vector.

M12. The method according to the preceding embodiment wherein the user data comprises a plurality of reference feature vectors obtained by converting a plurality of reference video segments indicative of a user's preference.

M13. The method according to the preceding embodiment wherein the plurality of reference video segments are indicative of different user preferences.

M14. The method according to any of the two preceding embodiments wherein the reference video segments are grouped into sets, each said set indicative of a particular user preference, and wherein each set is converted into a distinct user data subset comprising a subset of the reference feature vectors associated with the reference video segments forming part of it.

M15. The method according to the preceding embodiment wherein the feature vectors are assigned a score based on each user data subset.

M16. The method according to the preceding embodiment further comprising, for each feature vector, assigning a score based on a comparison to each of the user data subsets.

M17. The method according to any of the three preceding embodiments further comprising assigning a weight to each of the data subset, said weight associated with the user's relative preference towards it.

M18. The method according to any of the preceding embodiments wherein the user data comprises indication of frequency with which the given user watched a video and/or predetermined category of videos.

M19. The method according to any of the preceding embodiments wherein the user data comprises auxiliary data related to at least one video.

### Embodiments Related to the Segmentation Module

M20. The method according to any of the preceding embodiments further comprising, prior to selecting the neighborhood for each frame,
Via a segmentation module, generating at least one segment, each segment comprising at least one frame of the sequence of frames.

M21. The method according to the preceding embodiment wherein each neighborhood is comprised within a single segment.

M22. The method according to any of the two preceding embodiments wherein the segmentation module comprises a shot detector.

M23. The method according to the preceding embodiment wherein each segment corresponds to a shot detected by the shot detector.

M24. The method according to any of the four preceding embodiments wherein generating the plurality of segments is performed by a machine learning algorithm.

M25. The method according to the preceding embodiment wherein the machine learning algorithm comprises a neural network.

M26. The method according to the preceding embodiment, wherein generating the segments is performed by a convolutional neural network.

M27. The method according to any of the seven preceding embodiments wherein the segments are generated from the video by converting it to a one-dimensional signal, localizing its extrema and selecting intervals around them.

M28. The method according to the preceding embodiment wherein the segments are generated by converting the video into a segmentation curve and splitting the curve into segments such that
Each segment comprises a local maximum of the segmentation curve; and
Each segment starts and ends at a local minimum immediately preceding and following the said local maximum.

### Embodiments Related to the Highlighting Module

M29. The method according to any of the preceding embodiments and with features of embodiment M11 wherein assigning scores to the feature vectors comprises comparing each of the feature vectors with each of the reference feature vectors and assigning scores to the associated neighborhoods based on each input feature vectors' difference with respect to closest matching of the reference feature vectors.

M30. The method according to the preceding embodiment and with features of embodiment M14 wherein assigning scores to the feature vectors further comprises determining which user data subset is closest to each feature vector and assigning it a value based on a comparison between the subset of reference feature vectors and said feature vector.

M31. The method according to the preceding embodiment and with features of embodiment M17 further comprising accounting for the relative weight of each of the user data subset when assigning scores to the feature vectors.

M32. The method according to any of the preceding method embodiments wherein assigning scores to the feature vectors further comprises using a machine learning algorithm.

M33. The method according to the preceding embodiment wherein the machine learning algorithm comprises a neural network.

M34. The method according to the preceding embodiment and with features of embodiment M30 wherein the input into the neural network is a difference between each feature vector and the data subset that is closest to it.

M35. The method according to any of the two preceding embodiments further comprising, prior to any other steps, training the neural network to receive a plurality of feature vectors and output assigned scores for feature vectors.

M36. The method according to the preceding embodiment wherein no further training of the neural network is performed based on the input user data.

### Embodiments Related to Selection Module

M37. The method according to any of the preceding method embodiments further comprising, the selection module constructing the highlight segment.

M38. The method according to the preceding embodiment wherein the highlight segment comprises a plurality of frames selected from the input sequence of frames.

M39. The method according to the preceding embodiment wherein the highlight segment is constructed by evaluating assigned scores of all feature vectors corresponding to the frames and their neighboring frames and identifying a plurality of neighboring frames with an average best assigned score.

M40. The method according to the preceding embodiment further comprising constructing the highlight segment in such a way that it comprises a predetermined length.

M41. The method according to the preceding embodiment wherein the predetermined highlight segment length is based on predetermined segment classification.

M42. The method according to any of the two preceding embodiments and with features of embodiment M20 further comprising constructing the highlight segment in such a way that it is comprised in one segment.

Below is a list of system embodiments. Those will be indicated with a letter “S”. Whenever such embodiments are referred to, this will be done by referring to “S” embodiments.

S1. A system for selecting a highlight segment, the system comprising
A receiving module configured to
   Receive a sequence of frames, and
   At least one user data;
A converting module configured to
   For each frame, select a local neighborhood around it, said neighborhood comprising at least one frame, and
   Convert each neighborhood into a feature vector;
A highlighting module configured to
   Assign a score to each of the feature vector based on the user data;
A selection module configured to
   Select at least one highlight segment based on the scoring of the feature vectors; and
An output component configured to output the highlight segment.

S2. The system according to the preceding embodiment further comprising at least one database comprising a plurality of user data associated with particular users.

S3. The system according to the preceding embodiment wherein the database comprises a plurality of reference video segments.

S4. The system according to any of the two preceding embodiments wherein the reference video segments are user-selected and indicative of user preference for video segments.

S5. The system according to any of the three preceding embodiments wherein the user data is generated from a plurality of video segments based on at least one user-specific characteristic.

S6. The system according to any of the preceding system embodiments wherein the user data comprises a plurality of reference feature vectors obtained by converting a plurality of reference video segments indicative of a user's preference.

S7. The system according to the preceding embodiment wherein the plurality of reference video segments are indicative of different user preferences.

S8. The system according to any of the two preceding embodiments wherein the reference video segments are grouped into sets, each said set indicative of a particular user preference, and wherein each set is converted into a distinct user data subset comprising a subset of the reference feature vectors associated with the reference video segments forming part of it.

S9. The system according to the preceding embodiment wherein the feature vectors are assigned a score based on each user data subset.

S10. The system according to the preceding embodiment wherein each feature vector, is assigned a score based on a comparison to each of the user data subsets.

S11. The system according to any of the three preceding embodiments wherein the highlighting module is further configured to assign a weight to each of the data subset, said weight associated with the user's relative preference towards it.

S12. The system according to any of the preceding system embodiments wherein the user data comprises indication of frequency with which the given user watched a video and/or predetermined category of videos.

S13. The system according to any of the preceding system embodiments wherein the user data comprises auxiliary data related to at least one video.

S14. The system according to any of the preceding system embodiments further comprising a segmentation module configured to generate a plurality of segments, each comprising a plurality of frames of the video.

S15. The system according to the preceding embodiment wherein each neighborhood is comprised within a single segment.

S16. The system according to any of the two preceding embodiments wherein the segmentation module comprises a shot detector and wherein each segment corresponds to a shot detected by the shot detector.

S17. The system according to any of the three preceding embodiments wherein generating the plurality of segments is performed by a machine learning algorithm.

S18. The system according to any of the preceding system embodiments wherein the highlighting module is configured to use a machine learning algorithm to assign scores to the feature vectors.

S19. The system according to any of the preceding system embodiments wherein the selection module is configured to construct the highlight segment.

S20. The system according to the preceding embodiment wherein the highlight segment comprises a plurality of frames selected from the input sequence of frames.

S21. The system according to the preceding embodiment wherein the selection module is configured to construct the highlight segment by evaluating assigned scores of all feature vectors corresponding to the frames and their neighboring frames and identifying a plurality of neighboring frames with an average best assigned score.

S22. The system according to any of the preceding system embodiments further comprising a user terminal configured to display at least the highlight segment output by the output component.

S23. The system according to any of the preceding system embodiments configured to carry out the method according to any of the preceding method embodiments.

The present technology will now be discussed with reference to the accompanying drawings.

### BRIEF DESCRIPTION OF THE DRAWINGS

FIG. 1 depicts an embodiment of a method for selecting highlight segments according to an embodiment of the present invention;

FIG. 2 schematically shows a system for selecting highlight segments with several optional elements;

FIG. 3 shows an exemplary procedure for converting frame sequences according to an aspect of the present invention;

FIG. 4 shows a schematic embodiment of the present advantageous procedure for selecting highlight segments.

### DESCRIPTION OF EMBODIMENTS

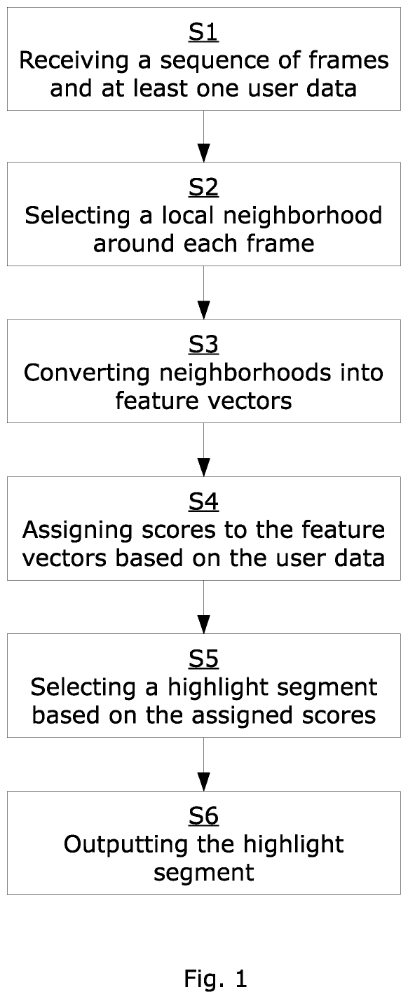

FIG. 1 shows a method according to an embodiment of the present invention. The method can be advantageously used to select highlight segments. Particularly, the method can be used to generate and output personalized video highlights or “segments” for users based on certain predetermined user data.

In a first step, S1, a sequence of frames is received or input together with at least one user data. The frames can comprise images such as frames in a video. Additionally or alternatively, the frames can comprise point clouds or light fields. Further, 3D video frames or compilations from a plurality of cameras can be considered as frames within the present disclosure. Put differently, the frames can correspond to encoding or projections of the real world/computer- generated content.

In a preferred embodiment, a video comprising a sequence of frames is input. The video may be temporally subsampled, so that the frames may not be directly consecutive. In other words, some frames from the video may be skipped. That is, the sequence of frames can also be irregularly sampled from the video.

The sequence of frames can then be processed as per S2, to select a local neighborhood around each frame. This can be performed by a converting module. The generated neighborhoods may each comprise at least one frame. The local neighborhood of a given frame may comprise the given frame, along with a few frames adjoining it. In the case of a video or a processed video serving as input, the neighborhood can correspond to a temporal interval centered around the given frame. The neighborhood may correspond to e.g. 5 to 21 frames, with the given frame and between 2 and 10 frames selected on either side of it according to the sequence of frames that is input. The neighborhood may also correspond to a single frame, which would then be the given frame.

In the third step, the neighborhoods can be converted into feature vectors by a converting module (the converting module may be used to perform both steps S2 and S3, but they can also be performed by separate modules, submodules, algorithms, or the like). The feature vectors can comprise embeddings and/or vectors in an n-dimensional vector space.

In the fourth step, S4, the feature vectors are assigned scores based on the user data. This step can be performed by the highlighting module, where the user data may also be input (e.g. from a database comprising user data and/or reference data based on which user data can be generated). The scores assigned to the neighborhoods can refer to determining how similar each of them is to user preference for highlight segments (e.g. video highlight segments), defined or represented by the user data, and sorting them according to this similarity. For example, the user data may comprise one or more video segments corresponding to a given user's interests or preferences. Such user-specific segments may then be used as a reference or as a benchmark for the incoming segments, so that segments of the input sequence of frames (e.g. a video) most similar to the given user's interests may be ranked as such or assigned an appropriate score based on this.

Step S5 comprises selecting a highlight segment based on the assigned scores. This can be done by a selecting module. The selecting module can construct the highlight segment based on a set of scores assigned to each of the neighborhoods. This construction can be based on considering not only the top assigned scores, but average scores of a plurality of consecutive frames. This can allow to avoid selecting the highlight segment based on one top scored frame, which may be due to noise. In other words, the selection or construction of the highlight segment can be performed by evaluating the scores assigned to each frame (represented by a neighborhood) and selecting a plurality of consecutive frames which were all assigned a relatively high score on average.

In step S6, the highlight segment is output. The outputting may be performed by an output component. In one specific example, the outputting may refer to providing or displaying the segment to the user.

To summarize, the present advantageous method may be used to identify video highlights based on individual user preference. It may also then be used to automatically generate a video highlight for a given user and provide it to them. For example, the present method may be used as part of a content provider's algorithm for ensuring that each user gets shown a preview or highlight of a video that may pique their interest and maximize their engagement, resulting in them watching the entire video.

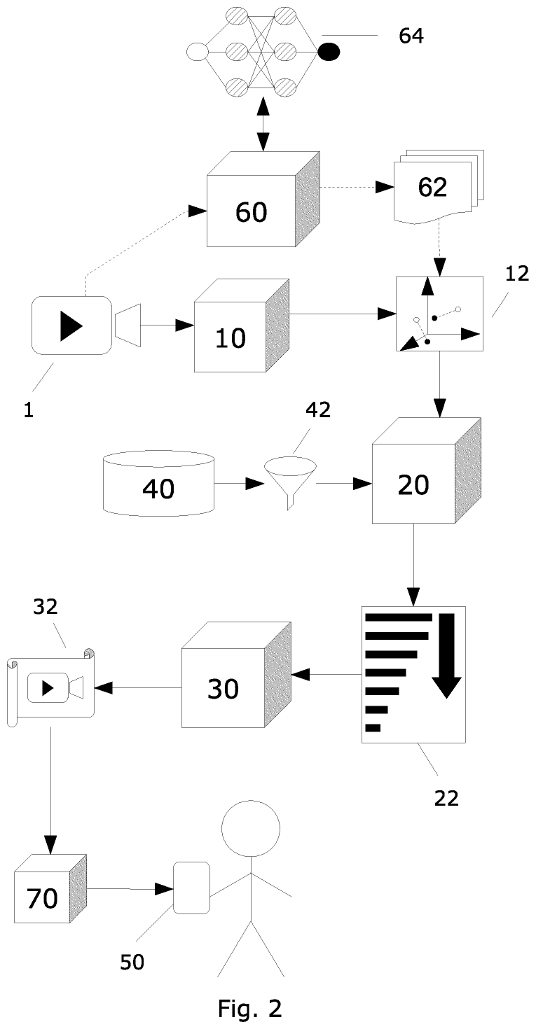

FIG. 2 schematically depicts an embodiment of a system for selecting video segments according to an aspect of the present invention. Some elements of the system are optional, and are depicted in FIG. 2 merely on an exemplary basis. A skilled person will understand that such elements may be skipped or replaced by appropriate alternatives.

In FIG. 2, an exemplary sequence of frames (depicted as a video) 1 is shown to be input into a converting module 10. The converting module 10 may comprise an algorithm and/or a routine and/or a subroutine that can be implemented to run on a local and/or remote and/or distributed processor so as to execute certain instructions. In other words, the converting module 10 may comprise a computer-implemented algorithm with a particular purpose and defined inputs and outputs.

The converting module 10 can select a local neighborhood around each frame. The local neighborhood may correspond to a few frames on each side of the given frame. If the input comprises a video, the local neighborhood may correspond to a short excerpt of this video with a few frames before and after the central frame forming it.

The converting module 10 then converts neighborhoods into feature vectors 12. Note, that neighborhood selection and conversion into feature vectors can also be done by separate modules, submodules, algorithms, or the like.

An optional part of the system comprises the segmentation module 60. The segmentation module 60 can generate a plurality of segments 62 based on the sequence of frames 1. The segments 62 may be generated, for example, by running the sequence of frames 1 through a neural network 64, that can be configured to extract appropriate segments from it. The segments 62 may be defined based on comparison between frames of the video 1 to determine e.g. a change of scene. In other words, the segmentation module 60 can comprise a shot detector, which can identify and separate different shots present in the input sequence of frames (or a video). The neural network 64 may be a convolutional neural network specifically trained to extract segments from videos. The generated segments 62 may be used to ensure that each of the neighborhoods 12 does not intersect a segment boundary. In other words, each neighborhood 12 may be comprised by one segment only. This is useful, as scoring of neighborhoods as feature vectors can be made more accurate by ensuring that each of the neighborhoods converted into a feature vector does not include a segment boundary (e.g. a shot boundary).

The generated feature vectors 12 may then be input into a highlighting module 20 together with a user data 42. The user data 42 may be stored in a user data database 40. Additionally or alternatively, data that can be used to immediately provide user data 42 can be optionally stored in the database 40. For example, the database 40 may comprise a selection of video segments generally considered interesting or relevant by a plurality of segments. The user data 42 may then be further personalized for a particular user by selecting only those video segments that they would find particularly interesting. The selection can be done based on user characteristics (such as e.g. demographic parameters) and/or be user-defined.

The user data 42 may be indicative of a given user's preference for videos. For example, the user data 42 may comprise user-selected (or automatically collected) video segments indicative of their interests. Such segments may be grouped into sets indicative of different categories of user interests. For example, one set may comprise user-selected videos showing cats, and another set may comprise user-selected videos showing paragliding. The user data 42 may further comprise user-selected or user-specific videos that have been transformed into a format where they can be easily used for benchmarking or filtering the extracted segments from the input video. For example, the user data 42 may comprise user-preferred videos converted to reference feature vectors such as n-dimensional vectors. The frames from the input sequence of frames can then also be converted into such feature vectors, and compared with the user data 42 by computing the distance between them. If the user data 42 comprises multiple sets of user-preferred videos (optionally converted into a particular format), each of the feature vectors of the input video may be compared with each of the sets, and a similarity or “closeness” score may be computed for each of the cases. In this scenario, the set for which the feature vector has the highest similarity score may be considered as a reference set and the distance or difference between the feature vector (of the input video segment) and the reference feature vector corresponding to this set may be further considered for assigning a score.

The user data 42 may also optionally comprise auxiliary data, which can comprise e.g. metadata. This can comprise data related to videos, such as comments, reactions to videos, graphic features added by users to various videos, or the like.

The highlighting module 20 is configured to output scores assigned to the input feature vectors based on the user data 42. The assigned scores 22 may be given e.g. based on similarity (or similarity score) to the user data 42. Put differently, each of the feature vectors from the input sequence of frames may be compared to the user data 42 (indicative of a user's preference for particular videos), and the segments most similar to the user's preference as indicated by the user data 42 are ranked as top segments or assigned highest scores. However, the scores may not correspond purely to the distance between feature vectors and reference vectors. Rather, this distance may be the input to the highlighting module, which can then use machine learning techniques to select the highest ranked segment, which may not be the one corresponding to the feature vector with the lowest distance to one of the reference feature vectors. The machine learning techniques used to assign scores to the feature vectors (and therefore the frames) may comprise neural networks and may be trained with annotated data (such as e.g. segments ranked as most entertaining by a group of test users).

A selection module 30 receives the assigned scores from the highlighting module 20 and selects or constructs a highlight segment 32 based on these scores. The highlight segment 32 may comprise a plurality of sequential frames that were assigned higher average scores than average scores of all other subsets of sequential frames. In other words, the scores are evaluated by the selection module, and a certain subset of the input sequence of frames selected. This selected subset then comprises sequential frames with highest average assigned scores. This can be done to avoid selecting a highlight segment based on one top assigned score, as this score may be a fluke or due to various sources of noise.

The highlight segment 32 is then output by the output module 70. The output module 70 may provide the highlight segment to the user associated with the user data 42. For example, the output module 70 may send the highlight segment 32 to a user terminal 50, which can then play the segment to the user. As the highlight segment 32 is determined based on the user's individual preference, the user may immediately know whether they would consider the input sequence of frames (or video) 1 in its entirety interesting, and whether they should watch it or not. In this way, the user may advantageously save time, by only watching videos they would likely be interested in. The user terminal 50 is also optional. The output component 70 may instead output the highlight segment 32 to a general user interface and/or save it in a database for future use.

The present system can allow to automatically select highlight segments from videos based on users' preferences. Furthermore, it can take into account different categories of user preferences, such as for example an interest in cats and an interest in paragliding. The different interests can be separately considered as different subsets of user data and therefore different sets of reference feature vectors. Each of the frames of the input video (and the associated neighborhoods) can be advantageously compared with the most similar subset of user data.

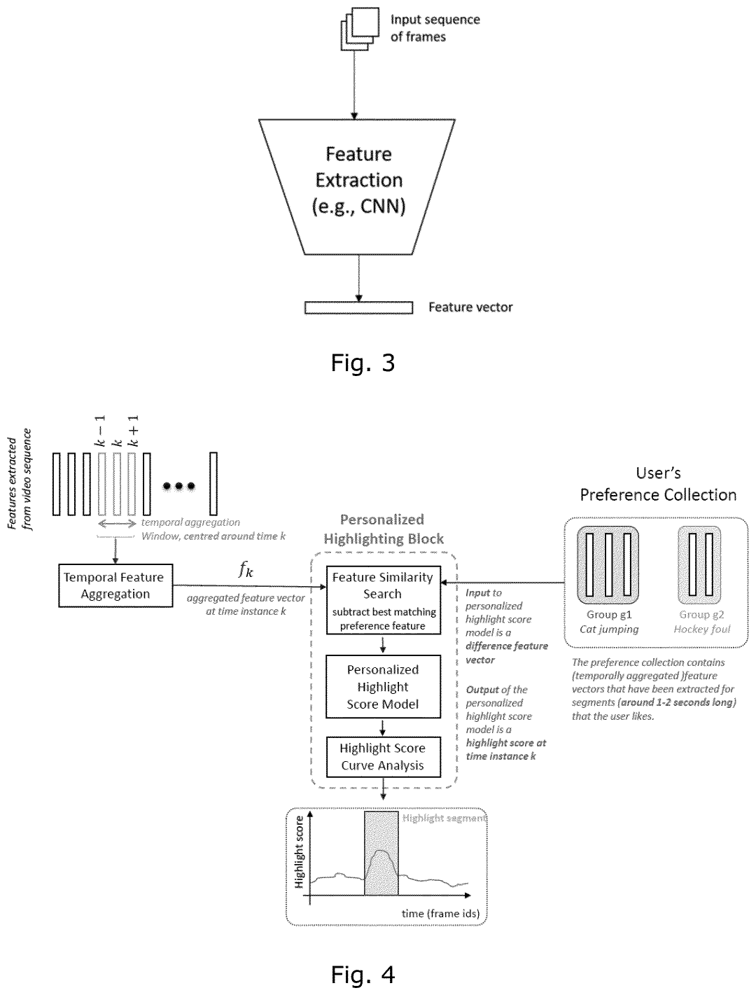

FIG. 3 schematically depicts a part of the present method for selecting video segments corresponding to an exemplary implementation of part of present method. The depicted part presents an example of converting an input sequence of frames into a format where they can be quantitatively compared with a user data. More specifically, the frames input into a converting module, and feature vectors are output. The converting module may comprise a neural network, such as a convolutional neural network. The resulting feature vector may be an embedding or a vector in an n-dimensional space, which can then be compared with similar user-specific reference feature vectors indicative of a user's preference for videos.

FIG. 4 depicts a schematic embodiment of personalised highlighting system and method according to an aspect of the present invention.

The neighborhoods or temporal aggregation windows of an input video (or sequence of frames) can be generated based on each frame of said video (or sequence of frames), with an interval comprising a certain number of frames (preferably corresponding to a certain temporal interval) on each side of the frame in question, thereby defining an interval corresponding to a neighborhood. In the figure, the frame in question is denoted by k, and the frames on either side of it (based on the sequence of frames in the video) as k−1 and k+1.

The neighborhoods extracted from an input video may be converted into feature vectors (denoted in the figure as fₖ, and then input into a highlighting module. The highlighting module may then perform a three-step process.

In a first step, the feature vectors can be compared to reference feature vectors of user data (with potentially different subsets of reference feature vectors used). The comparison may comprise computing the distance between the vectors and, for each feature vector, identify the reference feature vector with the smallest distance and its corresponding subset. This is shown by depicting the different subsets of user data as filters, where one filter may comprise videos showing jumping cats, and another hockey fouls. The feature vectors input into the personalised highlighting module may be filtered according to user data indicative of a user's preference. The preference may comprise different categories or sets. In FIG. 4, the user preference comprises two sets: videos related to cats jumping and videos related to hockey fouls. These can be treated separately, so that each preference category is individually evaluated.

In a second step, the feature vectors or preferably the smallest distance between feature vectors and reference feature vectors corresponding to user interests can be assigned scores.

In a third step, which has been previously referred to as performed by the selection module, the scores assigned to each feature vector (corresponding to neighborhoods based around individual frames) are evaluated. This can be done, for example, by analyzing a curve comprising all of scores assigned to the individual frames, and locating intervals of this curve with highest average scores. An exemplary highlight score curve is shown in the graph in FIG. 4. Selection and/or construction of the highlight segment may be performed based on an analysis of this curve.

The personalized highlighting module can be advantageously trained to take a user's history into account, in a way that no training is required to add new users with potentially very different preferences.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be the preferred order, but it may not be mandatory to carry out the steps in the recited order. That is, unless otherwise specified or unless clear to the skilled person, the order in which steps are recited may not be mandatory. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A computer-implemented method for selecting a highlight segment, the method comprising
Receiving
A sequence of frames, and
At least one user data;
Via a converting module,
For each frame, selecting a local neighborhood around it, said neighborhood comprising at least one frame and
Converting each neighborhood into a feature vector;
Via a highlighting module, assigning a score to each of the feature vectors based on the user data;
Via a selection module, selecting at least one highlight segment based on the scoring of the feature vectors; and
Via an outputting module, outputting the highlight segment.

2. The method according to claim 1 further comprising generating and maintaining a database of video segments and selecting at least one video segment as user data based on at least one characteristic associated with the user.

3. The method according to claim 1 further comprising, prior to the inputting step, receiving at least one reference video segment indicative of a user's preference and converting it into the user data and wherein converting the video segment comprises converting the reference video segment into a reference feature vector.

4. The method according to claim 3 wherein the user data comprises a plurality of reference feature vectors obtained by converting a plurality of reference video segments indicative of a user's preference.

5. The method according to claim 4 wherein the plurality of reference video segments are indicative of different user preferences and wherein the reference video segments are grouped into sets, each said set indicative of a particular user preference, and wherein each set is converted into a distinct user data subset comprising a subset of the reference feature vectors associated with the reference video segments forming part of it.

6. The method according to claim 5 wherein the feature vectors are assigned a score based on each user data subset and wherein the method further comprises for each feature vector, assigning a score based on a comparison to each of the user data subsets.

7. The method according to claim 5 further comprising assigning a weight to each of the data subset, said weight associated with the user's relative preference towards it.

8. The method according to claim 1 further comprising, prior to selecting the neighborhood for each frame, via a segmentation module, generating at least one segment, each segment comprising at least one frame of the sequence of frames.

9. The method according to claim 8 wherein each neighborhood is comprised within a single segment.

10. The method according to claim 3 wherein assigning scores to the feature vectors comprises comparing each of the feature vectors with each of the reference feature vectors and assigning scores to the associated neighborhoods based on each input feature vectors' difference with respect to closest matching of the user feature vectors.

11. The method according to claim 5 wherein assigning scores to the feature vectors further comprises determining which user data subset is closest to each feature vector and assigning it a value based on a comparison between the subset of reference feature vectors and said feature vector.

12. The method according to claim 11 further comprising accounting for the relative weight of each of the user data subset when assigning scores to the feature vectors.

13. The method according to claim 1 further comprising the selection module constructing the highlight segment and wherein the highlight segment comprises a plurality of frames selected from the input sequence of frames.

14. The method according to claim 13 wherein the highlight segment is constructed by evaluating assigned scores of all feature vectors corresponding to the frames and their neighboring frames and identifying a plurality of neighboring frames with an average best assigned score.

15. The method according to claim 13 further comprising the selection module constructing a plurality of highlight segments, each comprising a plurality of frames selected from the input sequence of frames, and corresponding to a plurality of distinct neighboring frames with an average highest assigned score.

16. A system for selecting a video highlight segment, the system comprising
A receiving module configured to
Receive a sequence of frames, and
At least one user data;
A converting module configured to
For each frame, select a local neighborhood around it, said neighborhood comprising at least one frame;
Convert each neighborhood into a feature vector;
A highlighting module configured to
Assign a score to each of the feature vector based on the user data;
A selection module configured to
Select at least one highlight segment based on the scoring of the feature vectors; and
An output component configured to output the highlight segment.

17. The system according to claim 16 further comprising at least one database comprising a plurality of user data associated with particular users and wherein the database comprises a plurality of reference video segments and wherein the user data is generated from a plurality of video segments based on at least one user-specific characteristic.

18. The system according to claim 16 further comprising a segmentation module configured to generate a plurality of segments, each comprising a plurality of frames of the video.

19. The system according to claim 18 wherein each neighborhood is comprised within a single segment.

20. The system according to claim 16 wherein the selection module is configured to construct the highlight segment and wherein the highlight segment comprises a plurality of frames selected from the input sequence of frames.

21. The system according to claim 20 wherein the selection module is configured to construct the highlight segment by evaluating assigned scores of all feature vectors corresponding to the frames and their neighboring frames and identifying a plurality of neighboring frames with an average best assigned score.

22. The system according to claim 16 further comprising a user terminal configured to display at least the highlight segment output by the output component.
